(19) United States
(12) Patent Application Publication
(10) Pub. No.: US 2019/0120498 A1
(43) Pub. Date: Apr. 25, 2019

(54) OVEN FOR COOKING / REGENERATING FOODS WITH DYNAMIC MULTILEVEL COOKING / REGENERATION SYSTEM

(71) Applicant: LAINOX ALI S.P.A., Milano (MI) (IT)

(72) Inventors: Moreno ZANCHETTA, Vittorio Veneto (TV) (IT); Marco FERRONI, Conegliano (TV) (IT)

(21) Appl. No.: 16/165,153

(22) Filed: Oct. 19, 2018

(30) Foreign Application Priority Data
Oct. 19, 2017 (IT) 102017000118499

(51) Int. Cl. F24C 7/08; F24C 15/30; F27D 11/00; A21B 7/00

(52) U.S. Cl. CPC F24C 7/086; F24C 7/085; F24C 7/087; G06F 3/04883; F27D 11/00; A21B 7/00; F24C 15/30

(57) ABSTRACT

Oven for the cooking/regeneration of food with a dynamic multi-level cooking/regeneration system with a multi-level cooking/regeneration chamber having at least two cooking/regeneration levels and wherein at least one timer and detecting sensors of cooking/regeneration parameters, such as at least temperature and/or humidity, are associated with each level, the oven being provided with a cooking/regeneration system that through a command and control interface enables the setting, the management and the control of at least two timers for at least one level of the oven.

The present invention relates to an oven for the cooking/regeneration of food with a dynamic multi-level cooking/regeneration system.

The invention finds particular although not exclusive application in the sector of production and marketing of cooking/regeneration ovens mainly intended for the foodservice industry as well as in the sector of production and marketing of equipment for the cooking and/or regeneration of food.

### PRIOR ART

In the prior art various equipment solutions are known, by type and operation, which are intended for the cooking of food, be they for domestic use or for the foodservice industry. Also known are solutions of equipment for the foodservice industry, which allow to obtain a type of food processing commonly known by the term regeneration, this term designating a particular cooking mode. Equipment is also known both for domestic cooking and for the foodservice industry, which allows to perform both cooking as such and to carry out a regeneration of food, since said cooking/regeneration possibilities are combined in one single apparatus. Among the known solutions of equipment for the cooking/regeneration of food, the ovens with a multi-level cooking/regeneration system, which are particularly intended for the foodservice industry, have been known for a long time. Said ovens enabling the cooking/regeneration of food are notoriously arranged for the cooking/regeneration of food with a multi-level cooking/regeneration system in order to obtain a processing of the food put in the cooking chamber, thanks to which said food can be prepared on a daily basis; the most required and widespread system usually requires a kitchen on site and the meal to be eaten in the same place where it was cooked a given time immediately after production. By “regeneration” one means both a phase of processing of the so-called cook and chill system and a phase of the cook and freeze system. The first implies a processing technique by which the food, hot packaged, after cooking/regeneration, is subjected to a fast cooling passing in a very short time from an upper temperature to another considerably lower temperature determined at the core of the processed product, to be then, after having been preserved for a few days, reactivated or regenerated upon eating of the meals by means of suitable ovens intended to determine a suitable increase in the temperature of the product maintained for a given time by the cooking characteristics of the product itself, usually said latter step providing a temperature of +120° C. for about 30 minutes or more. In the second case, on the other hand, the products are pre-cooked, enclosed in single-serving or multi-serving containers, then subjected immediately afterwards to a cooling process to −30° C. and preserved at −18° C. until regeneration with—mainly convection—ovens.

With particular reference to the technical sector of multi-level cooking/regeneration, this is a particular option provided by specific cooking/regeneration equipment that allows to manage the cooking/regeneration time or temperature at the core of the food of every single tray or grate, placed on different levels with respect to each other, on the oven rack. It is known that an oven for the foodservice industry, like gas-convection ovens, steam ovens, mixed ovens or even electrical ovens, comprises a large cooking/regeneration chamber, inside which, by means of an access door, some trays are positioned on top of each other, wherein each tray or crate, positioned on a different level from the others with respect to the bottom of the cooking/regeneration chamber, is intended to contain the food to be cooked or regenerated. This cooking/regeneration will be subject to and bound by the setting of the cooking/regeneration parameters, wherein said parameters will have to be homogenous for the food inserted in the various levels. In this case at least one probe, with multiple needles as well, will be used for each tray in such a way that the sensor can detect the temperature at the core of the food to be cooked/regenerated. In the prior art, again with reference to the cooking/regeneration equipment of the multi-level type, be it of the convection or of the combined type, in some cases the cooking/regeneration is managed in such a way as to provide the association of a time count by means of timers settable for every single level of the trays or the grates present in the cooking/regeneration apparatus. In the cooking/regeneration equipment provided with said management each timer is set and activated simultaneously to the insertion of the product to be cooked/regenerated in correspondence of the chosen level in such a way as to generate an acoustic and/or visual signal such as to inform about the end of cooking in the indicated level, also indicating the number and/or the position corresponding to the monitored level, the cooking/regeneration time by level being able to be displayed or not in a suitable graphical interface with which the cooking/regeneration apparatus can be equipped. In the prior art it is also known that in such types of cooking/regeneration equipment the cooking/regeneration times can be set manually or by assigning a predefined program to each level, which includes the setting of a predefined cooking/regeneration time according to a series of available programs, which vary depending on the dish to be cooked/regenerated and which will have to be compatible with each other in terms of cooking/regeneration mode depending on whether they are of the convection, steam or combined type and on the cooking/regeneration temperature. Said type of cooking/regeneration equipment, through a series of probes at the core of the food to be cooked/regenerated, may also be able to manage the various cooking/regeneration levels also by detecting that the temperature at the core of the dish to be cooked/regenerated has been reached.

In patent literature some solutions of cooking/regeneration equipment of the multi-level type including systems for managing one single or multiple cooking/regeneration levels can be found, among which—by way of example only—mention should be made at least of the following:

D1 no. US20080280000 (RATIONAL)
D2 no. EP 1653833 (RATIONAL)
D3 no. IT 1380883 (LAINOX)

D1 synthetically describes a solution of a method for managing at least one cooking process in the cooking chamber of an oven by means of the possibility, implemented by means of an interface, of entering a multiple number of cooking parameters concerning at least one specific product to be cooked and/or a cooking program and at least one start and end time of the cooking of at least one product to be cooked and/or of at least one cooking program, wherein at least one cooking parameter can be selected, whereby, in dependence of the selection of the start time and/or end time in the selection of a multiple number of cooking products and/or cooking programs, said interface indicates when which cooking product is to be loaded into the cooking chamber and to be removed from the cooking chamber also based on at least one cooking parameter.

D2 synthetically describes a cooking device for regenerating products cooked in a regeneration chamber with which said cooking/regeneration device is provided, in said regeneration chamber at least two regeneration levels are arranged or can be arranged, said regeneration levels being placed at different heights and wherein each regeneration level is equipped with a timer able to send an alarm after a set regeneration time has elapsed.

D3 synthetically describes a method and system of multi-level cooking/regeneration for ovens for the cooking/regeneration of food to be served all at once that comprises a primary function of multi-level cooking/regeneration, in which, through the selection of a key from the primary function of multi-level cooking/regeneration, one accesses a secondary function that, in the phase of setting of a first level corresponding to the chosen tray with the food, activates a control mechanism that considers some times set afterwards, managing them in order to allow, in following guided phases, to load the trays to which the levels correspond, in order to take all the food out of the oven at the same time.

### Drawbacks

All the known solutions of cooking/regeneration ovens of the multi-level type that include systems for managing one single or multiple cooking/regeneration levels as in the known prior art have defects and limits that are translated into consequent disadvantages.

A first drawback, according to the applicant, that characterizes the multi-level oven solutions as in the known prior art, lies in the fact that the current solutions of multi-level ovens do not allow to perform the activation, management and control of more than one timer per level, thus being unsuitable for the possibility of dynamic management of the products to be cooked/regenerated per level of the cooking chamber.

A second drawback, according the applicant, that characterizes the multi-level oven solutions as in the known prior art, lies in the fact that the current solutions of multi-level ovens do not allow to also coordinate multiple timers per level depending on the position given to the products to be cooked/regenerated.

Another drawback, according to the applicant, that characterizes the multi-level oven solutions as in the known prior art, lies in the fact that the current solutions of multi-level ovens do not allow to dynamically adapt the positioning of one or more timers to corresponding sectors as in the levels of the cooking chamber in such a way that the positioning of the timers can be coordinated with the shifts of products being cooked/regenerated that may be made from one level to the other or even within the same level, thus obtaining corresponding shifts of corresponding timers in the command interface of the oven.

As a whole, from these introductory remarks, it is evident that it is essential to find some alternative solutions.

The aim of the present invention is also to avoid the above-mentioned drawbacks.

### SUMMARY OF THE INVENTION

This and other aims are achieved by the present invention according to the characteristics as in the appended claims by solving the arising problems by means of an oven for the cooking/regeneration of food with a dynamic multi-level cooking/regeneration system comprising a multi-level cooking/regeneration chamber comprising at least two cooking/regeneration levels and wherein at least one timer and detecting sensors of cooking/regeneration parameters, such as at least temperature and/or humidity, are associated with each level, said oven being provided with a cooking/regeneration system that by means of a command and control interface enables the setting, the management and the control of at least two timers for at least one level of the oven.

### Aims and Advantages

In this way, by the considerable creative contribution the effect of which constitutes an immediate technical progress, multiple advantages are achieved.

A first advantageous aim is to obtain an oven for the cooking/regeneration of food with a dynamic multi-level cooking/regeneration system through whose innovative structure one can avoid the mentioned drawbacks of the current solutions of multi-level ovens as in the known prior art, in particular allowing to perform the activation, management and control of more than one timer per level, thus advantageously allowing to perform a dynamic management of the products to be cooked/regenerated per level of the cooking chamber.

A second advantageous aim is to obtain an oven for the cooking/regeneration of food with a dynamic multi-level cooking/regeneration system through whose innovative structure one can also coordinate multiple timers per level according to the position given to the products to be cooked/regenerated.

Another advantageous aim is to obtain an oven for the cooking/regeneration of food with a dynamic multi-level cooking/regeneration system through whose innovative structure one can dynamically adapt the positioning of one or more timers to corresponding sectors as at the levels of the cooking chamber in such a way that the positioning of the timers can be coordinated with the shifts of the products being cooked/regenerated that should be made from one level to the other or even within the same level, it being possible to obtain corresponding shifts of the corresponding timers in the command interface of the oven.

These and other advantages will appear from the following detailed description of some preferred embodiments, with the aid of the schematic drawings enclosed, whose details of execution are not to be considered limitative but only illustrative.

### CONTENT OF THE DRAWINGS

FIG. 1 shows a view of the command interface of the oven for the cooking/regeneration of food with a dynamic multi-level cooking/regeneration system according to the present invention in the multi-level command/control screenful in a representation with no timers set;

FIG. 2 shows a view of the command and control interface of the oven for the cooking/regeneration of food with a dynamic mufti-level cooking/regeneration system according to the present invention in the multi-level command/control screenful in a representation with one timer set;

FIG. 3 shows a view of the command and control interface of the oven for the cooking/regeneration of food with a dynamic multi-level cooking/regeneration system according to the present invention in the multi-level command/control screenful in a representation for the setting of two timers per level;

FIG. 4 shows a view of the command and control interface of the oven for the cooking/regeneration of food with a dynamic multi-level cooking/regeneration system according to the present invention in the multi-level command/control screenful in a representation in which two timers are set in one level;

FIG. 5 shows a view of the command and control interface of the oven for the cooking/regeneration of food with a dynamic multi-level cooking/regeneration system according to the present invention in the multi-level command/control screenful in a representation with no timers set and in which function commands of a pre-set recipe are displayed;

FIG. 6 shows a view of the command and control interface of the oven for the cooking/regeneration of food with a dynamic multi-level cooking/regeneration system according to the present invention in the multi-level command/control screenful in a representation with one timer set following the dragging of a function command of a pre-set recipe;

FIG. 7 shows a view of the command and control interface of the oven for the cooking/regeneration of food with a dynamic multi-level cooking/regeneration system according to the present invention in the multi-level command/control screenful in a representation with two timers set in the same level following the dragging of a function command of a pre-set recipe;

FIG. 8 shows a view of the command and control interface of the oven for the cooking/regeneration of food with a dynamic multi-level cooking/regeneration system according to the present invention in the multi-level command/control screenful in a representation with two timers set in the same level and one timer in a new level activated following the dragging of the function command of a pre-set recipe;

FIG. 9 shows a view of the command and control interface of the oven far the cooking/regeneration of food with a dynamic multi-level cooking/regeneration system according to the present invention in the multi-level command/control screenful in a representation in which the possibilities of operating with the “drag and drop” mode on the timer commands are evident;

FIG. 10 shows a view of the command and control interface of the oven for the cooking/regeneration of food with a dynamic multi-level cooking/regeneration system according to the present invention in the multi-level command/control screenful in a representation of the timers following the settings as in FIG. 9.

### PRACTICAL REALIZATION OF THE INVENTION

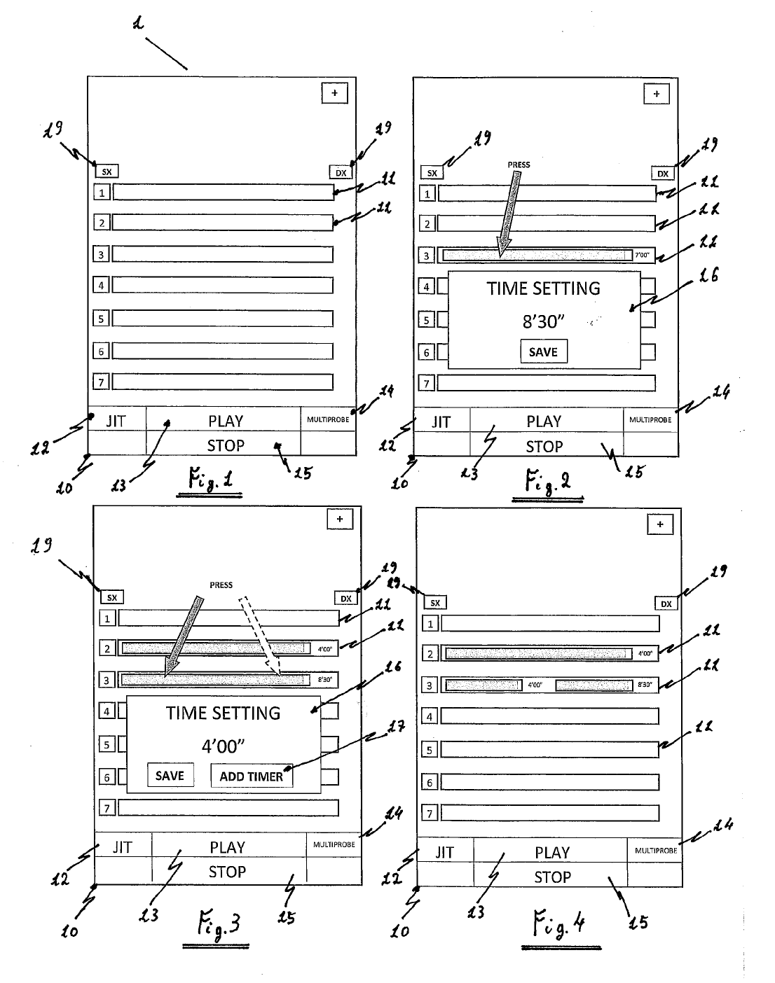

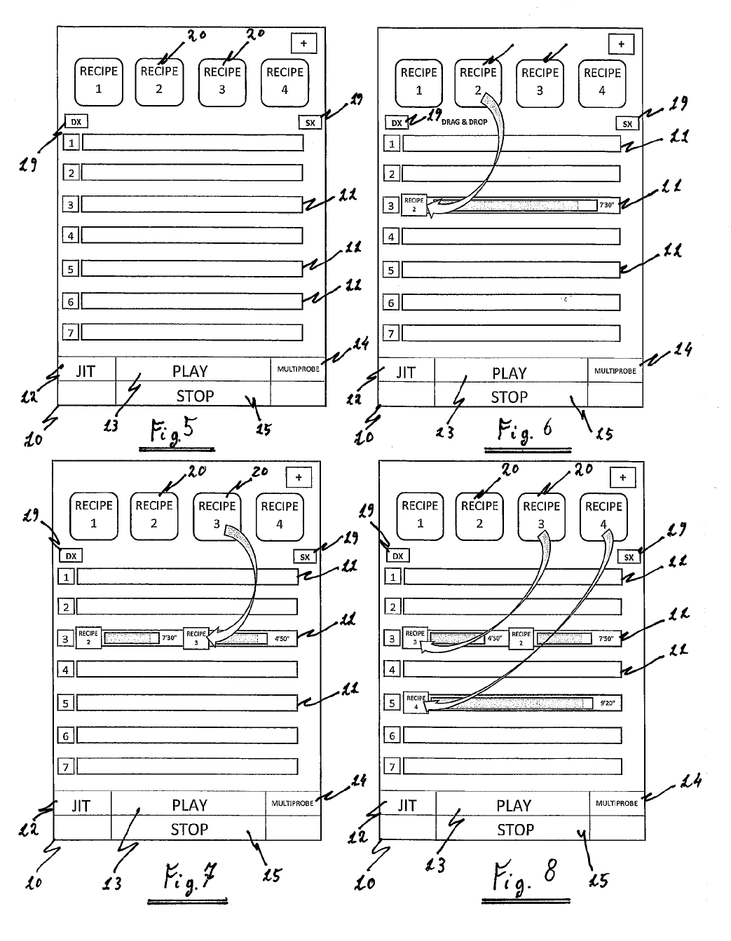

With reference to the drawings as well, an oven for the cooking/regeneration of food with a dynamic multi-level cooking/regeneration system (1) is described, which in the embodiment represented, as illustrated in FIGS. 1 to 10 that represent possible command settings of the dynamic multi-level cooking/regeneration system according to the present invention, in a multi-level oven (not shown) able to allow the cooking/regeneration of food, is conventionally provided with at least one cooking/regeneration chamber made in such a way as to comprise at least two cooking/regeneration levels and wherein in the embodiment described said cooking/regeneration levels are seven, this data not limiting the possible number of levels with which the oven according to the present invention can be provided. Furthermore, the multi-level cooking/regeneration oven according to the present invention is equipped with all the known devices that enable its operation as well as the management of the known cooking/regeneration phases, it possibly being, yet not limited thereto, of the convection or combined type and widely of the multifunction type.

In more detail as to the present invention, said multi-level oven can also be arranged to be intended to perform a management of cooking/regeneration, that, through suitable and known timer devices as well as being also possibly provided with sensors able to detect cooking/regeneration parameters such as at least temperature and humidity also at the core of the product to be cooked/regenerated, allows to associate a time count with each of the single insertion levels of the oven trays/grates, said oven being provided with a suitable command interface (10) for the command, the management and the control of the functions of the oven. The multi-level oven according to the invention is intended to allow that each timer with which it is provided can be set/activated simultaneously to the insertion of the product to be cooked/regenerated in the corresponding level in such a way that, at the end of the cooking/regeneration in the level, an acoustic and/or visual signal is generated, it also being possible to indicate, by means of the command interface (10) for command, management and control with which the multi-level oven is provided, the corresponding level at which the cooking/regeneration ended. Furthermore, the passing of time managed by said timers can be displayed or not in the interface (10) of the multi-level oven. In such a cooking/regeneration management system the assignment of times may take place by means of manual setting by the assigned operator or optionally also by attributing a predefined program to each level, in a series of available programs that for example can be indicated with the name of the dish to be prepared, containing the cooking/regeneration times that are compatible with each other in terms of cooking/regeneration modes and of the temperature at which the cooking/regeneration must take place.

Furthermore, in a known way, the multi-level oven according to the present invention provides the possibility of being able to manage the various levels also by monitoring the temperature or other cooking/regeneration parameters, such as, yet not limited thereto, parameters of humidity at the core of the product to be cooked/regenerated by providing the multi-level oven with a series of detection probes for detecting the temperature or other cooking/regeneration parameters at the core of the product to be cooked/regenerated. The multi-level oven according to the invention can also provide the possibility that the management of the various levels can occur in such a way as to allow that different products with different cooking/regeneration times and levels can all be simultaneously ready to be served, said mode being conventionally defined as “just in time”, that is to say, so as to allow the timers to be managed in such a way that the signalling of the end of cooking/regeneration can take place simultaneously for multiple products even if said products have different cooking/regeneration times for the different products to be cooked/regenerated and also different positioning levels at which said products can be located. In the “just in time” cooking/regeneration management mode the operator preliminarily sets up, by means of the command interface (10), for the command, the management and the control of the multifunction oven, said command interface (10) being provided with a suitable screenful comprising the function/control commands, which can also include indicators, the cooking/regeneration times in the different levels or, as an alternative, the assignment of predefined cooking/regeneration programs to said levels and whose cooking/regeneration times are related to the specific products to be cooked/regenerated. In the “just in time” mode, in order to provide the possibility of serving the products to be cooked/regenerated so that they are ready at the same time, each product to be cooked/regenerated is introduced, in the corresponding assigned level of the oven, according to a time sequence dictated, by means of suitable signalling from the command interface (10), by the cooking/regeneration times of each product to be cooked/regenerated according to a progressive sequence of the cooking times of each product the introduction of which in the corresponding level of the oven will be signalled starting from the product with the longest cooking times to the product with the shortest cooking times. In this way, since the timers of each level are coordinated on the basis of the determination of the simultaneous end of the cooking times of the products for each level, when all the coordinated times set have elapsed, one will obtain the possibility of getting—ready to be served at the same time—the cooked/regenerated products with different cooking/regeneration times as well.

As an innovation with respect to what has been previously described, the present invention provides an implementation of the possibilities of management of cooking/regeneration in a multi-level oven, multifunction as well, for the cooking/regeneration of food in such a way that the user is able to operate dynamically on the setting of the levels by means of the command interface (10) of the oven. The primary function of multi-level cooking/regeneration is accessed from a series of menus, in a command interface (10), wherein said menus are guided, from the turning on of the oven to the “MULTI-LEVEL” function so that, as shown by way of example in FIG. 1, the user can access a command screenful in which some function/control commands are iconized—said command interface (10) in the example including to this end a touchscreen display—which comprise at least one level function/control command (11) representing the levels of the multi-level oven, which are represented in a numerical sequence one below the other. Furthermore, and without limitation, in the example as in said FIG. 1, a “just in time” function/control command (12), representing the function for the “just in time” cooking; an activation function/control command (13); a function/control command of activation of the multiple probe management (14) for the management of the control probes of the parameters detected at the core of the product to be cooked/regenerated and a function/control command for program stop (15). By means of the command interface (10), as known, one can preliminarily set, by means of dedicated screenfuls, the cooking/regeneration parameters among which at least the cooking mode, depending on whether it should be carried out by means of convection, steam or of the mixed type; the cooking temperature, the degree of humidity. After said setting of the cooking parameters, it is possible to set the cooking times at one or more of the levels displayed in the corresponding screenfuls as in the command interface (10). Said settings can be carried out by the user on the command interface (10) in accordance with its structure, in the embodiment described, as in FIG. 1 and FIG. 2, said settings being carried out by pressing on the corresponding iconized function command as in the touchscreen command interface (10), it being also possible, however, for the user to perform the same commands with any known type of interface that can be used to realize the system according to the invention.

As shown in FIG. 3, it is also possible to perform a dynamic management of one or more of the levels of the multi-level oven, innovatively providing the possibility of command, management and control of more than one timer for the same level. In more detail as to the embodiment described and shown in FIG. 3, which shows a command screenful of the multi-level function as in the command interface (10), in which two levels are shown that are represented as previously set in such a way that for each level one single timer is set, the user, following a suitable action on a dedicated command, in the example on the level function/control command (11), which also allows to display the passing of time of the activated timer, can add one timer inside the same level, wherein in the described embodiment said command allowing to add one timer to the same level can be performed by the user exerting a suitable pressure on the level function/control command (11) as in the corresponding level to be set. In this way, the user can activate and set at least two timers for at least one level of the multi-level oven according to the present invention. As a non-exhaustive example, in the embodiment as in FIG. 3, the user can add an additional timer inside the same level also by exerting a pressure in correspondence of the right or left part of the bar of the level function/control command (11) representing the level corresponding to that in which one wants to activate an additional timer, depending on whether the addition of said additional timer is to be carried out in correspondence of the right side or the left side of the level that has been set. As an alternative, and again by way of example, the possibility of setting for the addition of a new timer in correspondence of a given level can be performed by the user exerting a continuous pressure always in correspondence of the right or left side of the bar that represents the level function/control command (11) after which pressure a timer addition button (17) will appear, whose activation will allow to add the new timer to the corresponding level in the position chosen by the user, said setting mask (16) being further provided with a command for saving the settings made (18). For the purpose of allowing the disconnection of one single timer, commands are possible, which enable the user to cancel one or more timers for each level.

The possibility as in the present invention of adding and setting more than one timer per level allows to make a subdivision of one or more levels of the multi-level oven into sectors that correspond to a settable timer, each timer possibly corresponding to an identified sector. In this way, the possibility of activating and setting more than one timer for the same level, given the connection of each timer to an identified sector of the level, consequently allows to identify the position of the product corresponding to the sector identified, in such a way as to enable the identification of the products placed inside the cooking chamber of the oven. In order to enable an easier identification of the sectors for the different levels identified by the corresponding timers, in the command and control screenful of the multi-level function as in the command interface (10) of the multi-level oven some informative representations of the identified sectors as in the corresponding timers are present, wherein said informative representations are in the form of information icons (19), in the embodiment described, as in FIGS. 1 to 10, said information icons (19) indicating a sectorisation of the levels of the oven corresponding to a right sector and to a left sector, in the example the settable timers for each level being two of which one corresponding to the right sector of the level and another one corresponding to the left sector of the level of the cooking chamber of the oven wherein, in the case in which the type of oven includes a cooking chamber intended to allow the insertion of the trays or grates transversely to the mouth of the oven the provided information icons (19) of the sectors of the levels will indicate sectors corresponding to a front and to a back.

A possible configuration provided by the solution according to the present invention, as shown in FIG. 5, also provides the possibility that the command and control screenful of the multi-level function as in the command interface (10) is provided with one or more function commands of a pre-set recipe (20), in the form of icons, wherein said function commands of a pre-set recipe (20) allow to activate “recipes/cooking programs” incorporating a cooking program preferably with one cycle only in which only the cooking mode, the time and optionally the degree of humidity of the product to be cooked/regenerated are identified, in which the execution of said function commands of a pre-set recipe (20) in one level rather than another will be subject to their compatibility with respect to the specific cooking mode and temperature preliminarily set for that specific multi-level cooking.

In more detail, with reference to the integration in the command and control screenful of the multi-level function of said function commands of a pre-set recipe (20), in order for the user to be assisted in the choice of their compatibility with the settings as in a level in relation to the homogeneity of the recipes to uniform cooking/regeneration parameters, their display in the function commands of a pre-set recipe (20) occurs on the basis of a compatibility selection of the cooking/regeneration parameters made by means of a suitable algorithm intended to make said selection of the recipes from all the recipes present in the database of the oven or in any databases present on a Web portal. In this way, by means of said selection made from the various recipes visible in the command and control screenful of the multi-level function, the user can have at his/her disposal recipes in which the association of the dish/time parameters is already set and available for a fast use avoiding the burden for the user to set said parameters.

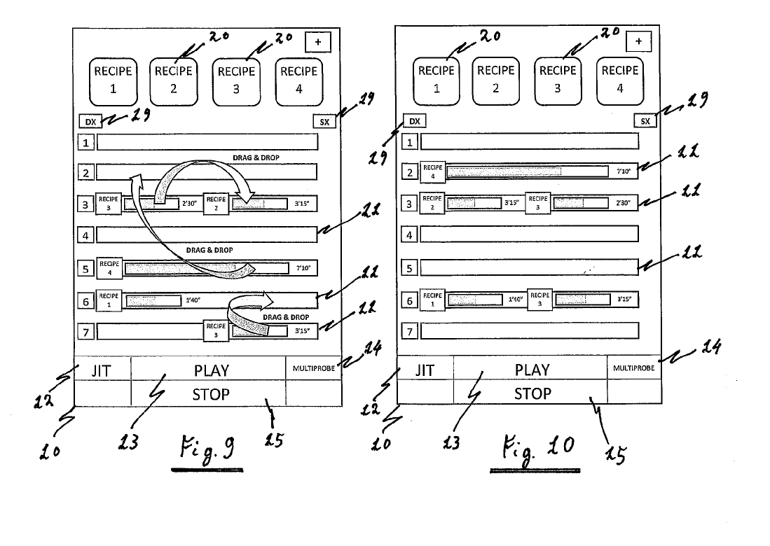

It is also provided that the function commands of a pre-set recipe (20) may be executed in such a way that the corresponding icons can also be provided with representative pictures of the product as in the corresponding recipe in such a way as to make it simpler to be identified. For a faster accessibility, in the present invention the activation of the function command of a pre-set recipe (20), as represented for example in FIG. 6 and in FIG. 8, for the activation of the timers in one or more levels of the oven can take place by means of the “drag and drop” function, that is to say, by dragging the icon corresponding to the function command of a pre-set recipe (20) to be activated in the bar that represents the level command/function (11) of the level of the oven whose time is to be activated with the cooking/regeneration time associated with the pre-set recipe. Furthermore, as shown by way of example in FIG. 7 and in FIG. 8, by dragging the icon corresponding to the function command of a pre-set recipe (20) to be activated in the bar that represents the level command/function (11), it is possible to add a recipe in one of the already occupied levels, thus activating in said level a new timer corresponding to a given sector, which can be right-hand or left-hand or front or back depending on the architecture of the cooking chamber of the oven, of the same level.

As shown in FIG. 9 and in FIG. 10, the solution according to the present invention, as an implementation function and through the possibility of acting by means of a “drag and drop” action on the icons of the level function/control commands (11) indicating already set and operating timers, provides the possibility for the user to be able to shift said timers from one level to another thus providing a greater flexibility in the organization of the space in the cooking chamber, particularly in the case in which two or more timers are activated in the same level, which are repeated in other levels. The described management possibility provided by the possibility of shifting the level function/control commands (11) as in already activated and operating timers, allows to manage the products being cooked/regenerated between the levels for example in such a way as to fill the sectors that in one or more levels of the cooking chamber of the oven were occupied by products whose cooking/regeneration cycle has already been completed for example in such a way as to enable the insertion of a level that has to be fully occupied, or to shift the timer inside the same level. Said management possibility being particularly advantageous in the case of ovens with a cooking chamber intended for the insertion of the trays in a front/back mode.

### REFERENCE

(1) Oven for the cooking/regeneration of food with a dynamic multi-level cooking/regeneration system;
(10) command interface;
(11) level function/control command
(12) “just in time” function/control command
(13) activation function/control command
(14) function/control command of activation of the multiple probe management
(15) function/control command for program stop
(16) setting mask
(17) timer addition button
(18) command for saving the settings made
(19) information icons
(20) function con command of a pre-set recipe

1. Oven for the cooking/regeneration of food with a dynamic multi-level cooking/regeneration system comprising a multi-level cooking/regeneration chamber comprising at least two cooking/regeneration levels, said oven being such as to comprise timer devices that are managed in such a way as to allow the association of a time count with each of the single levels of the oven and wherein the oven is provided with a command interface, settable by the user, for the command, the management and the control of the functions of the oven, said oven being able to be provided with devices for the detection of temperature or of other cooking/regeneration parameters at the core of the product to be cooked/regenerated, characterised in that the oven, by means of the command interface, allows to execute a cooking/regeneration system that comprises the setting, the management and the control of at least two timers for at least one level of the cooking chamber of the oven.

2. Oven for the cooking/regeneration of food with a dynamic multi-level cooking/regeneration system according to claim 1, characterised in that the command interface for the command, the management and the control of the multi-level functions comprises at least one level function/control command intended to allow at least the command of two timers for at least one level, said timers corresponding to sectorial portions of the level.

3. Oven for the cooking/regeneration of food with a dynamic multi-level cooking/regeneration system according to claim 1, characterised in that the command interface comprises at least one touchscreen display and dedicates, for the command, the management and the control of the multi-level functions, at least one screenful comprising, in the form of iconized commands, at least one level function/control command that allows the user to set one or more timers per level in such a way that each timer corresponds to an identified sector of the level, wherein the sectors of the level can be at least right and left or front and back.

4. Oven for the cooking/regeneration of food with a dynamic multi-level cooking/regeneration system according to claim 3, characterised in that the command interface comprises at least one touchscreen display and dedicates, for the command, the management and the control of the multi-level functions, at least one screenful comprising, in the form of iconized commands, at least one “just in time” function/control command; an activation function/control command control and a function/control command for program stop.

5. Oven for the cooking/regeneration of food with a dynamic multi-level cooking/regeneration system according to claim 3, characterised in that the command interface comprises at least one touchscreen display and dedicates, for the command, the management and the control of the multi-level functions, at least one screenful comprising, in the form of iconized commands, at least one function/control of activation of the multiple probe management for the management of the probes for the control of the parameters detected at the core of the product to be cooked/regenerated.

6. Oven for the cooking/regeneration of food with a dynamic multi-level cooking/regeneration system according to claim 1, characterised in that the screenful for the command, the management and the control of the multi-level functions comprises at least some information icons for each timer able to indicate at least the sector of the level with which the timer is associated.

7. Oven for the cooking/regeneration of food with a dynamic multi-level cooking/regeneration system according to claim 1, characterised in that the screenful for the command, the management and the control of the multi-level functions comprises at least one function command of a pre-set recipe incorporating a cooking program, said function command of a pre-set recipe being activable for each level depending on a check, made automatically, of the compatibility of the cooking/regeneration parameters.

8. Oven for the cooking/regeneration of food with a dynamic multi-level cooking/regeneration system according to claim 1, characterised in that the activation of the function command of a pre-set recipe for the activation of the timers in one or more levels of the oven can occur by means of a “drag-and-drop” mode by dragging the icon corresponding to the function command of a pre-set recipe to be activated in the bar that represents the level function/control command of the level of the oven of which one wants to activate the timer with the cooking/regeneration time associated with the pre-set recipe, also allowing to add a new timer to an already occupied level of the oven.

9. Oven for the cooking/regeneration of food with a dynamic multi-level cooking/regeneration system according to claim 1, characterised in that the command interface allows that the operativeness of at least the level function/control command can also be executed in the “drag and drop” mode by dragging from one level to another or inside the same level the icons representing the level function/control command indicating already set and operating timers.
